(19) United States
(12) Patent Application Publication
(10) Pub. No.: US 2010/0011602 A1
(43) Pub. Date: Jan. 21, 2010

(54) TEMPLATE FOR HANGING PICTURE FRAMES

(75) Inventors: Vazgen Houssian, Union City, NJ (US); Madlen Houssian, Union City, NJ (US); Deirdre Murphy, Montebello, NY (US)

Correspondence Address: DARBY & DARBY P.C., P.O. BOX 770, Church Street Station, New York, NY, 10008-0770, US

(73) Assignee: Nielsen & Bainbridge LLC, Paramus, NJ (US)

(21) Appl. No.: 12/354,588

(22) Filed: Jan. 15, 2009

Related U.S. Application Data
(60) Provisional application No. 61/021,208, filed on Jan. 15, 2008.

(51) Int. Cl. G01D 21/00; G01B 3/14

(52) U.S. Cl. 33/613; 33/562

(57) ABSTRACT

A template for assisting in the hanging of framed objects a predetermined distance from one another in which openings are spaced so that either the location for mounting hardware can either be marked or mounting hardware can be installed through the openings. The template may be used to position and visualize installation of subsequent framed objects.

### RELATED APPLICATIONS

This application claims the benefit of U.S. Provisional Application 61/021,208, filed Jan. 15, 2008.

### FIELD OF THE INVENTION

The present invention generally relates to the positioning and hanging of pictures, and more specifically to mounting uniformly-spaced picture frames on a wall using a template.

### BACKGROUND OF THE INVENTION

Many people choose to adorn the walls of their home with pictures, shadowboxes, signs or artwork. However, in order to maintain and contribute to the aesthetic qualities that these adornments provide, it is important that they are mounted straight and clean, with even spacing with respect to each other. To this end, devices and methods for leveling and spacing picture frames have been used.

Historically, spirit levels have been used in many applications as a cheap and easy method of ensuring that objects are either horizontally or vertically level. These spirit levels, comprised of a vial incompletely filled with yellow-colored ethanol, indicate a level surface when a bubble is located between two indicator lines. More recently, laser line levels, which mount to the wall and use an internal spirit level or pendulum to self-level, have been used to project a level line that can be used as an edge guide for mounting frames. And, of course, many different types of measuring devices have been used to measure the distance between objects and to provide guides for spacing. Tape measures, rulers, string, grids and lasers are among the many tools that have been used to measure distance and provide for desired spacing.

However, while levels and measuring tools may work in combination to mount one or two simple square or rectangular frames in a room, when mounting a plurality of frames with respect to each other, the use of the aforementioned tools and methodology quickly becomes complicated and often leads to mistakes. Not only are measurements and levels required for mounting frames with offsets, but multiple measuring and leveling steps are required to mark the wall for the locations to attach the frame mounting hardware (i.e., a nail or hook), resulting in a marred wall. Furthermore, as the number of frames to be mounted increases and the frame geometry becomes more complex, proper mounting requires an escalating number of different measuring and leveling steps in succession, making the process quite arduous and increasing the likelihood that mistakes will be made. This is especially troublesome when mounting frames in close proximity to each other as any discrepancies in spacing or leveling are more noticeable.

Therefore, what is needed is an inexpensive and simple way to hang picture frames that does not require multiple tools and numerous successive required steps, but yet ensures that the frames will be level and evenly spaced.

### BRIEF DESCRIPTION OF THE DRAWINGS

The foregoing and other features of the present invention will be more readily apparent from the following detailed description and drawings of illustrative embodiments of the invention in which:

FIG. 1 is a perspective view of a template in accordance with the present invention and a picture frame corresponding thereto;

FIG. 2 is a front view of a template in accordance with the present invention; and

FIGS. 3A-3C show the progression of using the template to mount additional frames with respect to one, two and three frames, respectively, that have been mounted in accordance with the present invention.

### DETAILED DESCRIPTION OF THE PREFERRED EMBODIMENTS

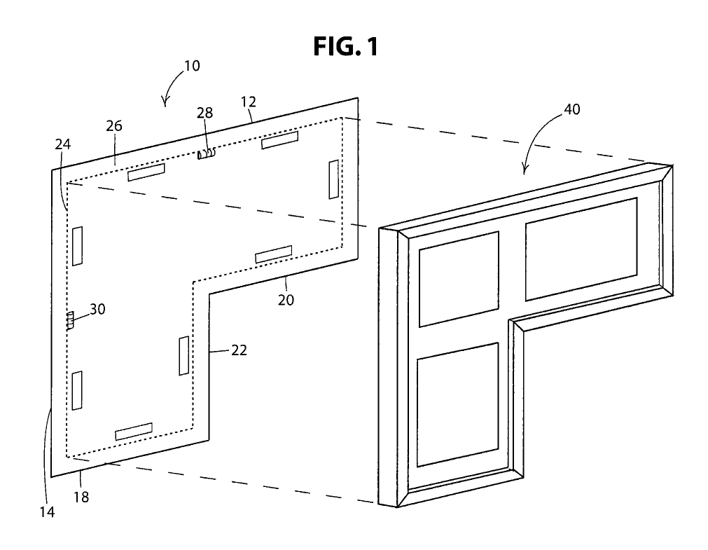

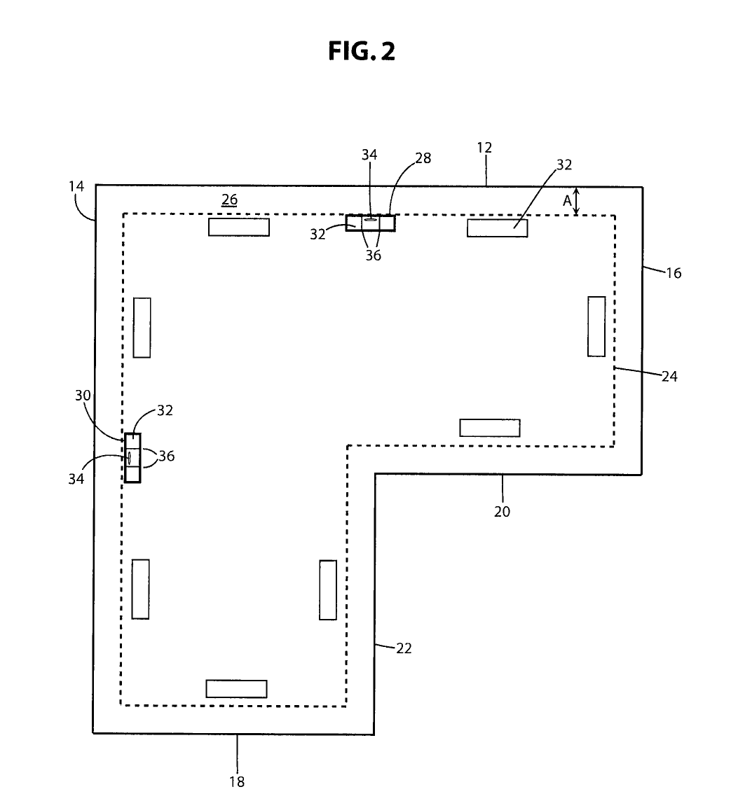

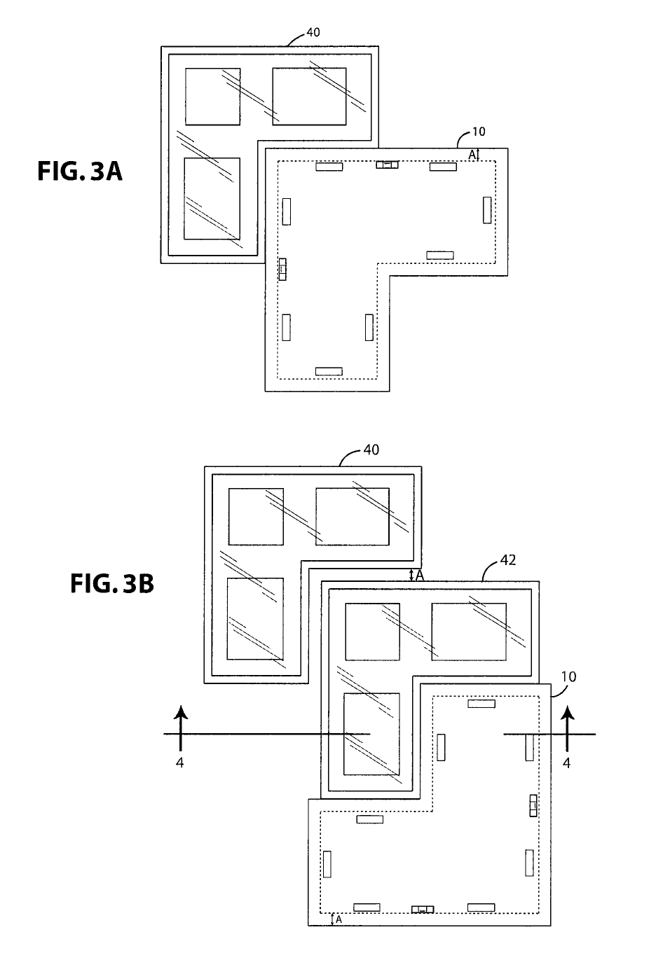

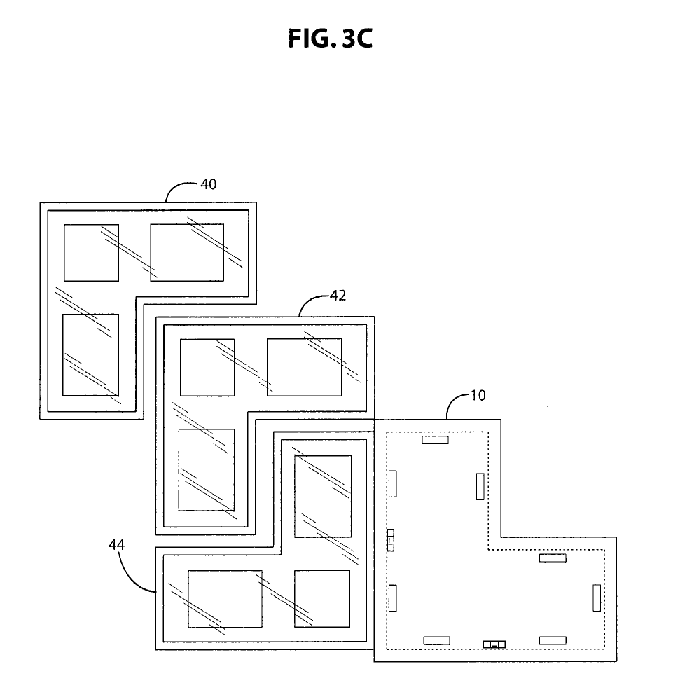

Referring to FIGS. 1 and 2, a template 10 for hanging a plurality of frames on a wall in a pattern with uniform spacing between the frames is disclosed. The template can be provided as part of kit that includes a plurality of frames and a corresponding template 10. The template 10 can be used by a user to hang the plurality of frames in a nearly limitless number of patterns and orientations on a wall while maintaining a uniform spacing between the frames. For example, one possible hanging pattern of frames is shown in FIGS. 3A-3C as an illustrative embodiment, which is discussed in further detail below.

FIG. 1 shows the template 10 and a frame 40 that is to be hung. The template 10, which corresponds to frame 40, is geometrically similar to the frame 40, but is scaled-up by a distance indicated by dimension A. Dimension A is a predetermined distance representing a predetermined desired spacing between frames, for example one inch; however other spacing distances may be used and the invention is not so limited. In the embodiment shown, the template 10 is an L-shaped figure with two equal legs having first and second long edges 12 and 14, first and second short edges 16 and 18, and first and second inner edges 20 and 22.

The template 10 may be composed of any number of different materials, such as plastic, aluminum or wood, and it may be a paper-based material such as cardboard since it is an inexpensive material that is easy to manufacture, cut and use. The frame 40 can be a picture frame, a shadow box, a sign, an artwork or any other piece of wall décor or item to be hung.

The template 10, which is larger in size than the frame 40 because of the spacing distance A, may be provided with indicia 24 to indicate what the bounds of the frame 40 will be once it is mounted on a wall and to show the size of a spacing border 26 located between the peripheries of the frame 40 and the template 10. The indicia 24, which is shown as a dashed line, but can be any other marking, allows the user to visualize where the outline of the frame will be when mounted on the wall. The template 10 may also be provided with first and second spirit levels 28 and 30, each comprising a vial 32 with indicator lines 36 and a bubble 34 contained therein (FIG. 2). While the first and second spirit levels 28 and 30 are shown just inside the indicia 24 near the center of the first and second long edges 12 and 14, they may be located anywhere on the template 10 so long as the vials 32 of the first and second spirit levels 28 and 30 are substantially parallel with the first and second long edges 12 and 14, respectively. Other leveling indicators may also be provided.

The template 10 may be further provided with openings 32 so that either the wall can be marked to indicate the location to attach frame mounting hardware or so that the hardware can be attached while the template 10 is against the wall. The openings 32, which may be any size and shape, but are preferably similar in size and shape to the frame mounting hardware, are cut-outs from the template 10 inside of the frame outline indicia 24 corresponding to mounting locations on the back of the frame 40. For example, the openings 32 may be small circles to mark a point to attach a nail, screw or hook and would correspond to a hook located on the back of the frame 40, or alternatively, could be representative of the size of the periphery of a hook, multiple screw or nail attachment locales or the size of a different type of attachment device, such as magnets or a slide and slot. Thus, while the template is against the wall, the location for attaching the hardware to the wall is marked so that once the template is removed, the mounting hardware can be attached to the wall and the frame can then be mounted on the wall. Alternatively, the opening 32 can be sized such that the mounting hardware can fit through the opening 32. Thus, while the template is still against the wall, the mounting hardware can be placed through the opening and then attached to the wall. After the mounting hardware is attached to the wall, the template can be removed, leaving the mounting hardware behind, and the frame can then be mounted with the attached mounting hardware.

The template 10 can be provided as part of a kit that includes a plurality of frames and a corresponding template 10. The plurality of frames all have substantially the same size and shape and the template provided in the kit has a corresponding size and shape to the frames. As discussed above the template has the same general shape as the frames except that is slightly larger so that a spacing border is provided. The kit can include three frames (e.g. frames 40, 42, and 44) and a corresponding template 10. The kit can have any number of frames. In addition to the frames and the template, the kit can also include the hardware necessary to mount the frames on the wall, as well as other various items. Alternatively, the frames and the corresponding template can be provided separately, so that for example, a user can purchase several packages of frames and a corresponding template which the user can use to assist in the mounting of the frames with uniform spacing between the frames.

In use the template 10 is placed on the wall at the desired location to hang a frame 40 and is adjusted clockwise or counter-clockwise so that either the first or second spirit levels 28 or 30 (whichever one has a horizontally oriented vial 32) shows that the template 10 is level, which is indicated by the bubble 34 being located midway between the indicator lines 36. Once the template 10 is located and leveled, the wall is marked at one or more of the openings 32, the template 10 is removed and the frame mounting hardware is attached at the locations where the wall was marked. Alternatively, as previously mentioned, the frame mounting hardware may be attached through one or more of the openings 32 while the template is still against the wall. Either way, once the template has been used to locate the frame mounting hardware and the frame mounting hardware has been attached to the wall, the frame 40 may then be hung.

FIGS. 3A-3C show the progression of successive hanging of additional frames in relation to the established position of the already-hung frame 40 of the plurality of frames to be hung. Each frame of the plurality of frames has substantially the same size and shape. To hang a second frame 42, the template 10 is placed back on the wall so that it abuts the frame 40. Again, the wall is marked at one or more of the openings 32, the frame mounting hardware is attached at the markings and the second frame 42 is hung. Because of the spacing border 26, there is a defined uniform spacing equal to distance A between frame 40 and 42 when they are hung on the wall. The template can be abutted against a hung frame so that the template can be quickly positioned and the location of the next frame can be easily marked and the spacing border 26 ensures that when the frames are hung there is a uniform spacing distance between them.

As shown in FIG. 3B, the third frame 44 is hung by placing the template 10 back on the wall so that it abuts mounted frame 42, the wall is marked at one or more of the openings 32, the frame hardware is mounted at the markings and the third frame 44 is hung. In this way, any number of successive frames may be mounted in accordance with the present method by placing the template 10 on the wall so that it abuts any frame that has already been hung, marking the wall at one or more of the openings 32, removing the template 10, attaching wall mounting hardware at the markings (or, alternatively, attaching the hardware through the openings while the template is still on the wall) and hanging the frame. The number of locations at which the template 10 may abut any previously-hung frame results in an endless number of possible mounting patterns and the spacing border 26 ensures that there will be uniform spacing between successively hung frames.

In other embodiments, the template and the plurality of frames may be provided with different shapes, such as a cross, t-shaped or polygonal. If alternative shaped frames are used a corresponding template can be provided having the same shape as the frame to be hung, but scaled-up in size to provide a desired spacing, similar to spacing A shown on template 10. For example, if a user wants to mount a plurality of T-shaped frames, having three equal legs, in different orientations with a spacing between frames of two inches, a template, similar to template 10 except having a T-shape corresponding to the frames, would be provided having a spacing border 26. One or more spirit levels could then be added to the template and openings 32 could be provided in the template corresponding to points on the rear of the T-shaped frame where it will be held on the wall.

In most cases, two spirit levels are provided, one being vertically oriented and the other horizontally oriented with respect to the edges of the template, so that one spirit level is usable (i.e., horizontally oriented) regardless of how a successive frame is to be mounted. For example, in the mounting of a frame as in FIG. 1, the first spirit level 28 is used to level the template 10 prior to marking the wall. However, if the next successive frame to be mounted has an orientation that is 90 degrees clockwise from the orientation of frame 40, the second spirit level 30 would be the one having a horizontal orientation when the template 10 is placed against the wall and would thus be used to level the template 10 prior to marking.

While the invention has been particularly shown and described with reference to preferred embodiments thereof, it will be understood by those skilled in the art that various changes in form and details may be made therein without departing from the spirit and scope of the invention.

What is claimed is:

1. A device for assisting in the hanging of a framed object comprising:
a template sized to be uniformly larger than a peripheral edge of the framed object;
indicia on a surface of the template that corresponds to the peripheral edge of the framed object, wherein the indicia are equally spaced inward from a peripheral edge of the template;
at least one leveling device mounted on the template to enable a substantially vertical orientation of the template; and
a first opening through the template located at a first position in which installing mounting hardware at the first position would enable the framed object to hang in a first framed object hanging position that is substantially within the space defined by the indicia on the surface of the template.

2. The device of claim 1, wherein the template is L-shaped and the at least one leveling device is mounted substantially parallel to the indicia.

3. The device of claim 1, further comprising:
a second leveling device mounted on the template substantially perpendicular to the at least one leveling device.

4. The device of claim 1, further comprising:
a second opening through the template located at a second position in which installing mounting hardware at the second position would enable the framed object to hang in a second framed object hanging position that is substantially within the space defined by the indicia on the surface of the template.

5. The device of claim 4, wherein the first framed object hanging position is oriented ninety degrees or one hundred eighty degrees from the second framed object hanging position.

6. The device of claim 1, wherein first opening permits marking of the location for the mounting hardware.

7. The device of claim 1, further comprising:
a frames used in conjunction with the template so that the frame may be hung within the space defined by the indicia on the surface of the template.

8. A device for assisting in the hanging of two or more framed objects next to each other and spaced apart by a distance measured from edges of the two or more framed objects closest to one another comprising:
a template having outer peripheral edges that are greater in size than outer peripheral edges of the two or more framed objects, other than the edges closest to one another, by one half the distance between the two or more framed objects; and
two or more openings through the template located at positions that permit installation of mounting hardware to hang the two or more framed objects at the spaced apart distance from edges of the two or more framed objects closest to one another and centered within the template.

9. The device of claim 8 further comprising:
indicia on a surface of the template that corresponds to outer peripheral edges of the two or more framed objects.

10. The device of claim 8 further comprising:
at least one leveling device mounted on the template to enable a substantially vertical orientation of the template.

11. The device of claim 8, wherein the two or more framed objects have at least one similar dimension.

12. The device of claim 8, wherein the two or more openings through the template permits the two or more framed objects to be hung in a second orientation that is rotated ninety degrees from a first orientation.

13. The device of claim 8, wherein the two or more openings through the template permits the two or more framed objects to be hung in a second orientation that is rotated one hundred eighty degrees from a first orientation.

14. The device of claim 8, wherein the two or more openings permit marking of the location for the mounting hardware.

15. The device of claim 8, further comprising:
two or more frames used in conjunction with the template so that the two or more frames may be hung the spaced apart distance from one another.

16. The device of claim 8, further comprising:
mounting hardware for use in conjunction with the template so that the two or more framed objects may be hung the spaced apart distance from one another.

17. A device for assisting in the hanging of two or more framed objects next to each other and spaced apart by a first distance measured from edges of the two or more framed objects closest to one another comprising:
a template having an outer peripheral edge that is spaced from an outer peripheral edge of the two or more framed objects, other than the edges closest to one another, by an amount that is one half the first distance; and
two or more openings through the template located at positions that permit installation of mounting hardware to hang the two or more framed objects at the spaced apart distance from edges of the two or more framed objects closest to one another and centered within the template.

18. The device of claim 17, wherein the two or more openings permit marking of the location for the mounting hardware.

19. The device of claim 17, wherein mounting hardware may be installed through the two or more openings and the template may be removed after installation of the mounting hardware.

20. The device of claim 17, further comprising:
two or more frames used in conjunction with the template so that the two or more frames may be hung the first distance from one another; and
mounting hardware for use in conjunction with the template so that the two or more framed objects may be hung the first distance from one another.
